(19) United States
(12) Patent Application Publication
(10) Pub. No.: US 2019/0105981 A1
(43) Pub. Date: Apr. 11, 2019

(54) ELECTROMOTIVE DRIVE WHEEL ARRANGEMENT

(71) Applicant: Muhr und Bender KG, Attendorn (DE)

(72) Inventors: Christoph Renner, Gosau (AT); Bernhard Spielvogel, Moosbach (AT)

(21) Appl. No.: 16/145,418

(22) Filed: Sep. 28, 2018

(30) Foreign Application Priority Data
Oct. 5, 2017 (EP) 17195068.6

(51) Int. Cl. B60K 7/00; B60B 3/10; B60B 27/00; H02K 1/04; H02K 1/27; H02K 7/00; H02K 7/102

(52) U.S. Cl. CPC B60K 7/0007; B60B 2900/113; B60B 27/0052; H02K 1/04; H02K 1/2786; H02K 7/006; H02K 7/102; B60K 2007/0092; B60B 2360/341; B60B 2360/10; B60B 2900/111; B60B 2900/311; B60B 2900/3312; B60B 2900/212; B60B 2900/511; B60B 3/10

(57) ABSTRACT

An electromotive drive wheel arrangement for a motor vehicle comprises: a stator that is connectable to a wheel carrier in a rotationally fixed manner and that supports a coil-like winding, and a rotor rotatably supported relative to the stator and configured in the form of a wheel rim and arranged at least partially radially outside around the stator, wherein the wheel rim comprises a rim base and a rim star, connected to each other, wherein the rim base includes at least partially a fiber-reinforced plastic, and in the rim base several magnets are integrated in a material connection, and that the rim star includes at least partially a metal material.

### CROSS-REFERENCE TO RELATED APPLICATIONS

This application claims priority to European Application No. EP 17195068.6, filed on Oct. 5, 2017, which application is hereby incorporated herein by reference in its entirety.

### BACKGROUND

It is known for electromotive drive wheel arrangements, to integrate an electromotor as a wheel hub motor in the inner chamber of a rim. The electromotor has a rotor as well as a stator. The rotor is connected to the rim and carries magnets, which produce the magnetic excitation field. The stator is arranged in a rotationally fixed manner to the wheel carrier and accommodates a coil-like winding. For producing the drive torque, electric current is transmitted through the coil-like windings of the stator and thus, produces a magnetic field, which magnetically interacts with the excitation field of the rotor. For the force and torque transmission between the drive wheel arrangement and the road surface, a tire is mounted on the rim. Wheel hub motors transmit the drive torque, thus, without interconnection of transmission gearings, but drive the rim and the tire directly via the rotor.

For operation of the wheel hub motor power and control electronics are necessary, which can be integrated directly in the structure of the wheel hub motor or can be placed on or in the car body.

An advantage of the wheel hub motor compared to common drive architectures with central drive is the omission of a multitude of drive train elements, like for example clutch, shifted transmission, differential gearing and drive shafts and the thus incurred reduction of transmission losses. Disadvantageous is the influence of the increase of the so called unsprung masses in respect to the drive safety and the drive comfort of the motor vehicle. They are the sum of the masses reduced to the vertical movement of the wheel centre of all the components moved along during the spring compression and rebound.

A variant of the wheel hub motors for motor vehicles is the type of an external rotor. The rotor comprises in this type an annular structure, which is arranged radially outside around the stator and carries on its inner circumference magnets, which are formed mostly like permanent magnets, however can also be designed as electromagnets. Between the radially inside face of the magnets and the radially outside face of the stator an air gap is provided, to enable a relative rotational movement between rotor and stator. For achieving a high efficiency of the wheel hub motor, the air gap is kept as small as possible and constant across the circumference, as the magnetic resistance of the magnetic fields also increases with increasing air gap.

From DE 10 2008 036 560 B4 a wheel hub motor is known, which corresponds to the type of an external rotor. The rotor is, in this case, formed by permanent magnets arranged on a vehicle rim. The permanent magnets are fixed by means of gluing or casting onto the rim. This can be carried out directly on the rim body or on an adapter ring made from a magnetically conductive material. For the pre-arranging, recesses can be provided in the bodies.

From WO 2016/0066769 A1 a vehicle rim is known, which is designed in two parts with a rim base and a rim star and which are connected at least by one connection element. The rim base is made from a fiber-reinforced plastic and the rim star is made from a metal material. An intermediate layer prevents completely or partially the direct contact of rim base and rim star, to prevent undesired chemical processes, like for example contact corrosion, of the two materials.

### SUMMARY

Disclosed herein is an electromotive drive wheel arrangement for a motor vehicle, especially for hybrid-electric vehicles and electric vehicles that, because of its structure increases the efficiency of the electromotor and leads to a reduction of the wheel weight.

An electromotive drive wheel comprises a stator connectable in a rotationally fixed manner to a wheel carrier and supporting a coil-like winding, and a rotor rotatably supported relative to the stator and formed in the form of a vehicle rim and arranged at least partially radially outside around the stator, wherein the vehicle rim comprises a rim base and a rim star, connected to each other, wherein the rim base consists at least partially of a fiber-reinforced plastic, wherein several magnets are integrated in the rim base by a material connection, and wherein the rim star consists at least partially of a metal material.

An advantage is, that fiber-reinforced plastics comprising a plastic matrix and reinforcement fibers have, compared with metal materials, a substantially lower density at similar tensile strength. By means of material-optimised selection of the geometry and the fiber orientation, thus a high stiffness of the rim base relative to the mass can be achieved, acting against an ovalisation of the rim or of the rotor, which is caused by static and dynamic portions of the relative rotating vertical wheel force. The air gap between the stator and rotor is thus kept as far as possible constant within a defined driving cycle, which increases the average efficiency of the wheel hub motor within the driving cycle.

Furthermore, by means of using fiber-reinforced plastic in the area of the rim base, thus on the one hand the masses of the wheel hub motor are reduced as part of the unsprung mass, and on the other hand the mass moment of inertia around the axis of rotation of the drive wheel is reduced. The reduction of the unsprung masses leads to an improvement of the driving safety characteristics and the driving comfort characteristics of the vehicle as well as to a reduction of the required electric energy within a defined driving cycle due to a lower mass of the complete vehicle to be accelerated. By means of reducing the mass moment of inertia of the drive wheel, the driving dynamics as well as the vehicle control are positively influenced and the required electric energy within a defined driving cycle is reduced by a lower mass to be rotationally accelerated.

The rim base is at least partially made from a fiber-reinforced plastic, wherein the possibility shall be included, that the rim base is mainly or completely made from fiber-reinforced plastic. Additionally to fiber-reinforced plastic, reinforcements made from a second material can be connected to and/or integrated in the rim base in a materially connecting manner, in a form-locking manner and/or in a force-locking manner. These reinforcements can for example be provided for optimising the stiffness of the rim base in relation to the loadings acting from the outside and an ovalisation resulting therefrom. Especially the areas of the rim, which are in direct contact with the tire, can be formed from a second material, for example a metal material. The reinforcements can in particular also assume the function of protecting the fiber-reinforced plastic from damages, for example contacts with the road curb.

A further feature is the material connective integration of the magnets in the rim base. The magnets can in this case be distributed in one or more rows across the circumference of the rim base. Magnets are bodies that produce a magnetic field or through which the magnetic field flows, especially permanent magnets and electromagnets. Material connective connections are present, when the connection partners, i.e., the magnets and the fiber-reinforced plastic, are held together by nuclear or molecular forces, for example by gluing, or by fusing. Besides the material connection also a form- and or force-locking connection can at the same time be present between the connection partners, in particular
the magnets can circumferentially be enclosed completely by fiber-reinforced plastic;
the magnets can be partially enclosed by fiber-reinforced plastic, while the part of the magnets which is not enclosed by the fiber-reinforced plastic, is exposed;
the magnets can partially be enclosed by fiber-reinforced plastic, while the part of the magnets that is not enclosed by the fiber-reinforced plastic is enclosed by a protection layer;
the magnets can partially be enclosed by fiber-reinforced plastic, while a portion of the part of magnets that is not enclosed by the fiber-reinforced plastic, is enclosed by a protection layer and the other part is exposed.

If, as described above, an additional protection layer encloses the magnets, this can be manufactured from the plastic matrix or from a different material.

The stator is a component arranged around the axis of rotation of the drive wheel and comprises in particular radially outwards extending stator teeth, which respectively end at the radial outer end with a pole shoe and which can support the coil-like windings. All coil-like windings of the wheel hub drive can be controlled by a power and control electronics system, which can be integrated directly into the structure of the wheel hub motor or can be placed on or in the vehicle body. The stator can be formed as a single-part component or a multi-part component, wherein the individual parts can optionally be fixed to each other. For example, the stator can comprise additionally a shaft, on which a wheel hub is rotatably supported.

The stator is connectable non-rotationally to a wheel carrier of the vehicle, so that the two components in the assembled condition cannot rotate relative to each other, i.e., a torque introduced by the stator is supported on the wheel carrier. It can be provided that, in addition to restrict the relative rotational degrees of freedom (rotational freedom of movement) of the two components relative to each other, also one or more relative translatory degrees of freedom (translator freedom of movement) of the components can be captured relative to each other.

In a preferred embodiment, the fiber-reinforced plastic is made from a plastic matrix and a semi-finished fiber product. The semi-finished fiber product is made by suitable textile technical processes, like for example weaving, braiding, layering and knitting or a combination of the named methods. The semi-finished fiber products can have a single-layered or a multi-layered structure. The alignment of the fibers within the semi-finished fiber product can be mono- or multi-axial. The layer structure and the alignment of the fibers can vary across the extension of the semi-finished product. Depending on the primary manufacturing process of the fiber-reinforced plastic the semi-finished products can be used dry or they are impregnated with the plastic matrix in advance. Such semi-finished fiber products allow for the local mechanical property of the resulting component to be adapted to the local loading, which can be used for a weight optimisation of the component in the design process.

According to a first embodiment, the magnets of the rotor can be designed as permanent magnets. To construct powerful and at the same time compact wheel hub motors, permanent magnets with very high magnetic energy density are used. The highest magnetic energy density is, in this case, achieved by rare earth magnets, which essentially comprise alloys from iron metals and rare earth metals that often have a very high susceptibility to corrosion. By means of the material connective imbedding into the rim base, the permanent magnets are additionally protected against outer environmental influences, so that the danger of corrosion of the magnets is reduced, which could lead to a power reduction, material dissolving or material destruction. Thus, process steps for stabilising the corrosive behaviour of the permanent magnets are omitted and more advantageous permanent magnets can be used with constant magnetic energy density. The permanent magnets can have a substantially straight shape or they can follow the contour of the rim base. In particular, the permanent magnets can correspond to an extruded annular segment and have inclined faces for removal from a die. By an extensive protection against environmental influences a target conflict between higher energy density and resistance to corrosion can be circumvented in the context of the development of novel permanent magnetic alloys for the use in wheel hub motors. According to a second embodiment the magnets can be configured as electromagnets in the form of coils of metal wires, embroidered into the semi-finished fiber product.

A possible embodiment of the electromotive drive wheel arrangement provides that the permanent magnets are connected to the semi-finished fiber product of the fiber-reinforced plastic. The permanent magnets can for example be sewn on or embroidered onto the semi-finished product. In a further exemplary embodiment, the permanent magnets are sewn into or embroidered into the layer construction, so that the permanent magnets are arranged between two layers of the semi-finished fiber product. In a possible embodiment, the permanent magnets have connection portions, which enable a connection, especially a sewing or embroidering. For example, these connection portions can be widenings like eyelets and feet arranged on the circumference.

For protection against dirt and other environmental influences the rotor can at least partially form a motor housing around the stator. In particular, the rim base forms a wall of the motor housing arranged radially outside around the stator. Furthermore, the rim star can have in an embodiment a closed shape, and thus forming a side wall of the motor housing. In this case, walls can be provided between the spokes. If the rim star is primarily shaped in a casting or forging process, the walls can be formed by the casting or forging skin between the spokes, which otherwise are removed in open rim stars in a further working step. This working step can be omitted in the embodiment with a closed side wall and thus a piece cost reduction with at the same time expansion of the component function can be achieved. In a further possible embodiment, a side wall of the motor housing arranged opposite to the rim star can be connected to the rim base or can be formed integrally with the rim base, so that the stator is arranged between the rim star and the side wall arranged opposite to the rim star. If the above described embodiments are used in combination, a substantially U-shaped motor housing is achieved relative to the axis of rotation of the drive wheel around the stator.

For sealing the inner chamber of the motor housing, in a possible embodiment a sealing element is arranged between the side wall arranged opposite to the rim star and the stator. In particular radial or axial shaft sealing rings can be used. By selecting a sealing running face, arranged close to the axis of rotation of the drive wheel arrangement, the relative circumferential velocity of the sealing partners and thus the wear of the sealing means is reduced. Furthermore, in the embodiment, in which the stator has a wheel hub, the rim star can be connected rigidly to the wheel hub and be rotatably supported on the stator. In this embodiment, the rim star is sealed relative to the wheel hub. For this, in particular any static seal known from the state of the art, for example a flat seal, an O-ring, a sealing compound or a sealing press-fit can be provided between the rim star and the wheel hub. The wheel hub can have one or several connection portions for accommodating one or more connection elements, in particular screws. If these connection portions are not essentially designed in the shape of a blind hole, but essentially as through bores, further sealing elements can be provided between the connection elements and the wheel hub or between the connection elements and the rim star. A further embodiment is characterised in that the rim base and the rim star are connected force- and/or form-lockingly and that a seal, for example a glue or a sealing compound, is introduced between the rim base and the rim star. The seal can be an intermediate layer composed of different materials and which takes on, besides the function of the seal, also the function of the force transmission between the rim base and the rim star. In particular, the seal in the areas of the spokes and in the areas of the wall between these, can be formed differently. A different possible embodiment provides, that the rim base and the rim star are connected in a material connection way, for example by means of gluing, and thus an additional seal can be omitted between the two parts.

For reducing the magnetic resistance and thus the produced increase of the magnetic flow, in an embodiment one or more metal strips, rotating with the magnets, can be integrated in the rim base.

In a possible embodiment a brake disc is connected by a material connection to the rim star or to the rim base, to achieve a compact construction with reduced assembly work.

### SUMMARY OF THE DRAWINGS

Example embodiments are described in the following using the drawings, which include:

FIG. 1 is a diagonal front view of an exemplary electromotive wheel hub drive arrangement;

FIG. 2 is a front view of the electromotive wheel hub drive arrangement of FIG. 1;

FIG. 3 is a schematic representation of a stator of the wheel hub drive arrangement of FIG. 1 in a longitudinal sectional view;

FIG. 4 is a longitudinal sectional view through the wheel hub arrangement of FIG. 2 along the section line IV-IV;

FIG. 5a sectional view through the wheel hub arrangement of FIG. 2 along the section line V-V;

FIG. 6a is a schematically a cut-out portion of the rim base of FIG. 4 in an enlarged representation in a first possible embodiment of the imbedding of the magnets;

FIG. 6b is a cut-out portion of the rim base of FIG. 4 in an enlarged representation in a second possible embodiment of the imbedding of the magnets;

FIG. 6c is a cut-out portion of the rim base of FIG. 4 in an enlarged representation in a third possible embodiment of the imbedding of the magnets;

FIG. 7a is a permanent magnet of the wheel hub arrangement of FIG. 1 as shown in detail in a perspective view; and

FIG. 7b is a permanent magnet of a modified embodiment for a wheel hub.

### DESCRIPTION

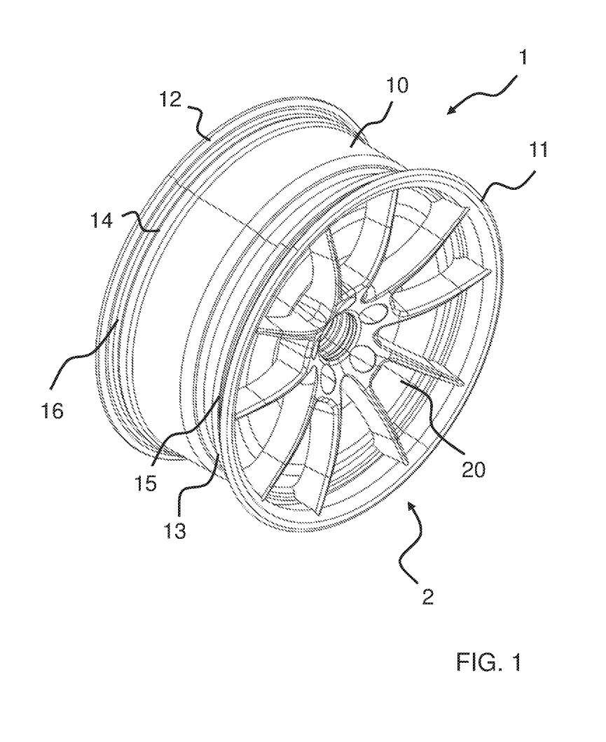

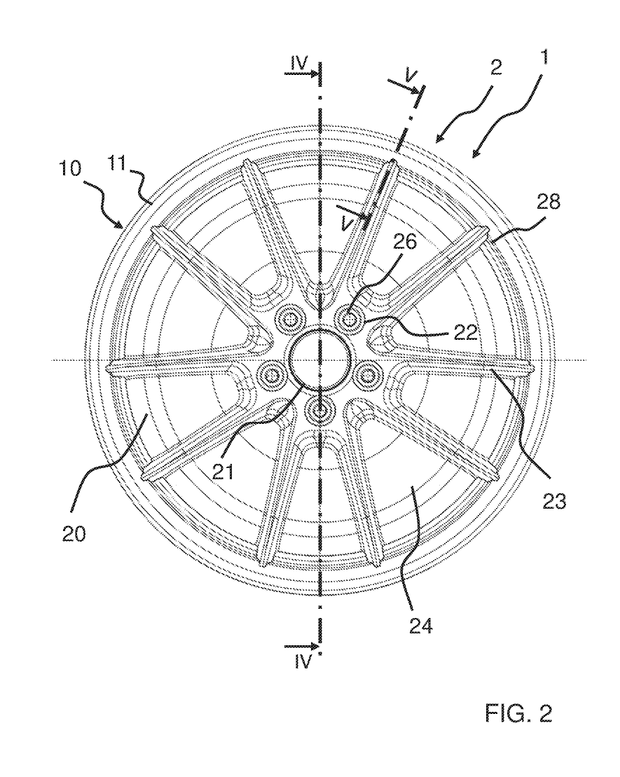

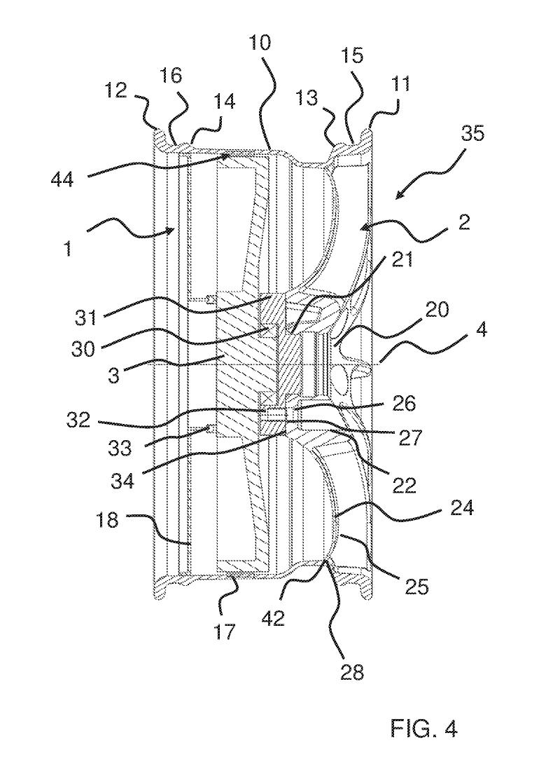

FIGS. 1 to 7, which in the following are described together, show an electromotive drive wheel arrangement 1. The drive wheel arrangement 1 comprises a rotor 2 and a stator 3, which are arranged around an axis of rotation 4. The drive wheel arrangement 1 is connected via the stator 3 to a wheel carrier not shown in the Figures.

The rotor 2 is made in the form of a wheel rim and comprises a radially outside arranged rim base 10 and a rim star 20, which are connected to each other in particular in a form-locking and force-locking way. Thus, between the rim base 10 and the rim star 20 a circumferentially extending, completely closed contact region 28 is formed, which in its extension can vary across the circumference. The rim base 10 is made from, i.e., at least partially or substantially comprises, fiber-reinforced plastic, which comprises a semi-finished fiber product and a plastic matrix. The layer structure and the fiber alignment vary across the extension of the semi-finished product, to adapt the mechanical properties of the rim base 10 to the loadings. In particular the semi-finished fiber product can be structured such that an as high as possible stiffness is achieved against ovalisation due to the vertical wheel forces. The rim base 10 can be produced in any suitable primary forming process for fiber-reinforced plastic. Depending on the manufacturing process used, the semi-finished fiber products are either dry and the plastic matrix is afterwards introduced, for example by means of resin injection methods, or the semi-finished fiber products are in advance impregnated with the plastic matrix, for example by means of winding methods. Reinforcements made from a different material, in particular a metal material, which have a reinforcing effect or serve for protection against damages of the fiber-reinforced plastic, can be connected in a force-locking, form-locking way or by means of material connection to the fiber reinforced plastic. On the rim base 10, a tire, not shown in the Figures, can be mounted, so that a bead of the tire rests in the outer rim shoulder 15 and the other bead of the tire in the inner rim shoulder 16. For this, the rim base 10 comprises an outer rim flange 11 and an inner rim flange 12, which axially secure the tire at the respective sides of the rim base 10, as well as an outer hump 13 and an inner hump 14, which prevent an axial displacement of the wheel respectively inwards during loading when driving around a bend. The above named portions, which serve for the axial retainment of the tire, can in particular be reinforced by metal reinforcements.

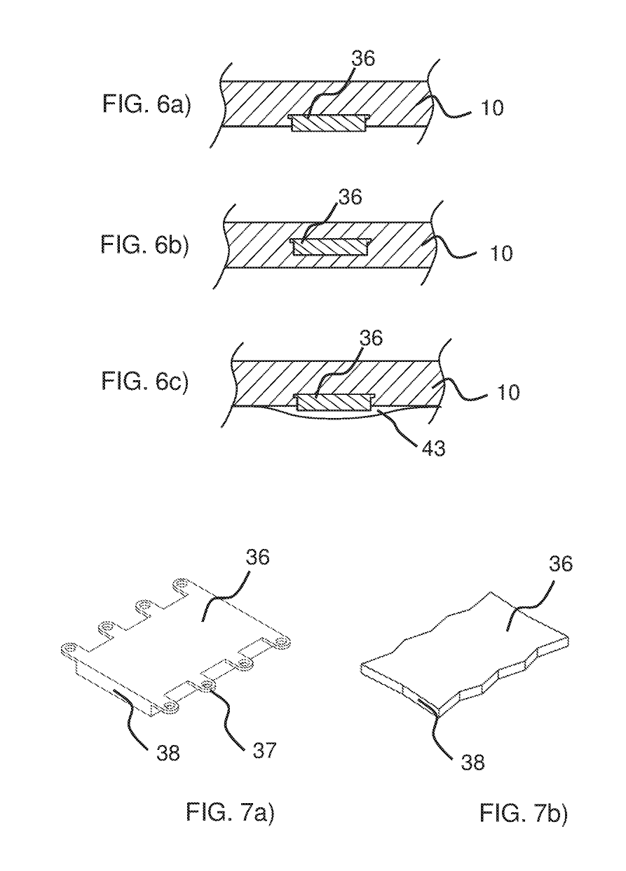

In the rim base 10, several magnets 17, which produce the excitation field of the electromotive drive wheel arrangement 1, are integrated by material connection. The magnets 17 are formed as permanent magnets 36 in the illustrated embodiments. Alternatively, the magnets 17 can be formed as electromagnets in shape of a coil of metal wires. FIG. 6a shows schematically a first embodiment of the integration of the permanent magnets 36 in the rim base 10, in which the permanent magnets 36 are partially enclosed by fiber-reinforced plastic, while the part of the magnets, which is not enclosed by fiber-reinforced plastic, is exposed. FIG. 6b shows schematically a second embodiment of the integration of the permanent magnets 36 in the rim base 10, in which the permanent magnets 36 are completely enclosed across the whole circumference by the fiber-reinforced plastic. FIG. 6c shows schematically a third embodiment of the integration of the permanent magnets 36 in the rim base 10, in which the permanent magnets 36 are partially enclosed by the fiber-reinforced plastic, while the part of the permanent magnets 36, which is not enclosed by the fiber-reinforced plastic, is surrounded by a protection layer 43. The protection layer 43 can consist of the fiber-reinforced plastic, the plastic matrix or a different material. The shown embodiments are in particular designed such that the permanent magnets 36 are protected as far as possible from outer environmental influences, which can lead to corrosion.

For the material connective integration of the permanent magnets 36 into the rim base 10, these can be connected to the semi-finished fiber product. This can in particular be achieved, depending on the layer structure of the semi-finished fiber product, by means of sewing-on or embroidering-onto the layer structure of the semi-finished fiber product. For this, permanent magnets 36 comprise connection portions 37 in shape of an eyelet, as shown in FIG. 7a). For an optimised controlling of the manufacturing processes the permanent magnets 36 can have inclined faces 38 for removal from a die. An alternative embodiment of the permanent magnets 36, in which the connection portions 37 are omitted, is shown in FIG. 7b. The permanent magnets 36 according to this variant are in particular introduced between two or more layers of the semi-finished fiber product. The embodiments of the permanent magnets 36, shown in the two FIGS. 7a and 7b have a substantially straight shape. The permanent magnets 36 can in particular also be formed in a shape following the profile of the rim base 10, i.e. corresponding to an extruded annular ring segment. A possible embodiment provides, that for reducing the magnetic resistance one or more metal strips circumferentially extending radially outside the magnets 17 are integrated in a material connection way into the rim base.

The rim star 20 is made of, i.e. comprises at least a metal material, wherein in an embodiment according to the invention individual portions can be manufactured from different materials. The rim star 20 comprises a centrally positioned wheel seat 21, accommodating centrally a wheel hub 31. Radially outside, the wheel seat 21 is surrounded in particular by five attachment holes 22, without limiting the number of attachment holes 22 thereto. By means of the attachment holes 22, connection elements 26, in particular screws, can be inserted and fixed to connection portions 32, in particular threads, provided in the wheel hub 31, so that the rim star 20 and the wheel hub 31 are rigidly connected to each other. Furthermore, the rim star 20 has several spokes 23, extending from the wheel seat 21 as far as possible radially outwards up to the contact region 28, wherein the spokes 23 can in particular have a straight as well as a curved shape. The spokes 23 can in particular be designed as multi-spoke such as Y-spoke for example. Between the spokes 23, walls 24 extend radially and in circumferential direction, so that the rim star 20 has a closed shape. This can in particular be achieved such that the casting- or forging-skin, formed during the primary forming by means of casting or forging of the rim star 20 between the spokes 23, is not removed. The spokes 23 and the walls 24 can be formed such that a closed wheel disc is achieved.

The stator 3 is a component arranged around the axis of rotation 4, which radially outside is partially enclosed by the rotor, in particular by the rim base 10. The stator 3 comprises several stator teeth 5, distributed around the circumference and extending radially outwards, with coil-like windings, which are not shown for simplicity in the Figure. The coil-like windings are connected to a power- and control-electronics system, not shown, and produce during current supply a magnetic field. The magnetic field interacts magnetically with the excitation field and, thus, produces in that manner the motor torque of the drive wheel arrangement 1. For optimisation of the magnetic flow, the outwards arranged ends of the stator teeth 5 are formed as pole shoes 6, which are arranged radially inside relative to the magnets 17 of the rotor 2. Between the pole shoes 6 and the magnets 17 the air gap 44 is arranged, which should be configured as small as possible and constant for a high efficiency of the electromotor during driving operation. This can be achieved by a high stiffness of the rim base 10 against ovalisation due to vertical wheel forces. The stiffness can for example be optimised by means of a corresponding, above described design of the semi-finished fiber product or by means of reinforcements in the fiber-reinforced plastic.

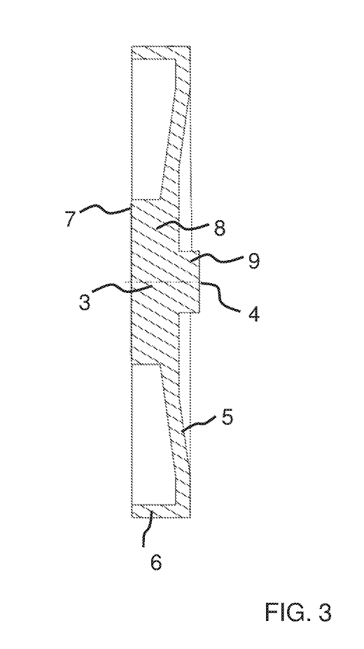

Furthermore, the stator 3 comprises a central portion 8, having on one side, in FIG. 3 on the left side—a connection portion 7 to the wheel carrier of the vehicle. By means of the connection portion 7, the stator 3 is connected to the wheel carrier in a rotationally fixed way, so that all relative rotational degrees of freedom and at least a relative translatory degree of freedom is captivated between the components, and thus a torque introduced into the stator 3 is supported by the wheel carrier. On the opposite side—in FIG. 3 on the right side—the stator 3 has a journal 9, which can accommodate a rotatable bearing element. The stator 3 is shown in a one-part embodiment. Alternatively, the stator 3 can also be formed from several parts, to integrate for example the connection portion 7 and the journal 9. On the journal 9 a wheel bearing 30 is mounted, which rotatably supports the wheel hub 31. The wheel hub 31 is again, as described above, connected to the rim base 10 in a rotationally fixed manner by means of connection elements 26.

The rim base 10 is connected at its radial inwards side in a material connection to a side wall 18 of a motor housing 35, so that the stator 3 is arranged between the side walls 18 and the rim star 20. The side wall 18 can, in this case, be manufactured from the same material as the rim base 10 or from a different material. As the rim star 20 is made in a closed shape from spokes 23 and walls 24, the rim star 20 takes over the function of a second side wall 25 of the motor housing 35.

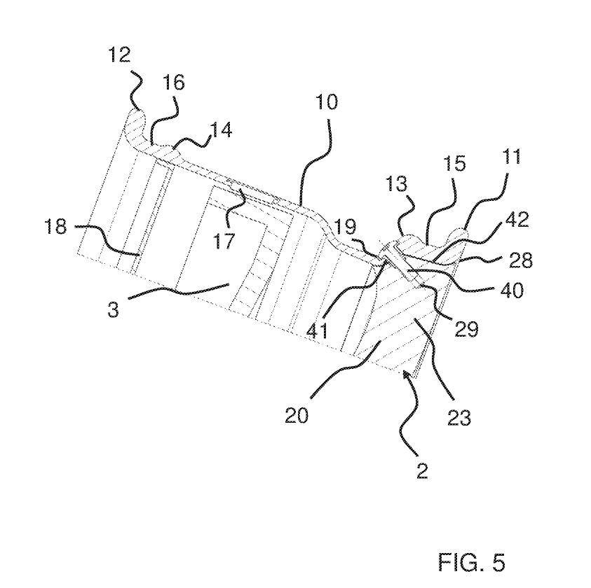

The side wall 18, the rim base 10 and the rim star 20 thus together form the motor housing 35, which is sealed relative to outside environmental influences. For this, a sealing element 33 is provided between a radially inward end of the side wall 18 and the stator. The sealing element 33 can in particular be a radial shaft sealing ring or an axial shaft sealing ring. The diameter of the sealing running face is selected as small as possible, so that the wear on the sealing element 33, with sufficient construction space for the connection between the stator 3 and the wheel carrier of the vehicle, can be reduced. The side wall 18 and the rim base 10 are connected to each other in a material connection, so that a seal is provided between the two components. The rim star 20 and the rim base 10 are connected force- and form-lockingly to each other. For this, as shown in FIG. 5, connection elements 40 are passed through openings 10 in the rim base 10 and are fixed in connection regions 29 of the rim star 20 in the area of the spokes 23. The connection elements 40 are in particular configured in the form of screws enclosed by sleeves 41, and the connection regions 29 of the rim star 20 are in particular formed as blind holes with a threaded portion. The connection elements 40 can in particular be glued to the rim base 10, the rim star 20 and the sleeves 41. The sleeves 41 take on a sealing function and absorb shearing forces, which act on the connection elements 40 due to the force- and torque transmission. For this, in particular, the sleeves 41 can be glued structurally to the rim base 10 and the rim star 20 and for example can be manufactured from an elastomer material. In the contact region 28 a seal 42 is provided between the rim base 10 and the rim star, which seal in the area of the spokes 23 comprises an intermediate layer with function regions for transmitting forces and torque as well as for sealing. The intermediate layer can furthermore decouple the two components such that a contact corrosion between the different materials of the rim base 10 and the rim star 20 is prevented. The contact region 28 is formed narrower the area of the walls 24 than in the area of the spokes 23; and the seal 42 is made from a sealing compound, so that in this area (28) substantially only a sealing effect and secondarily a force- and torque-transmission results. The intermediate layer and the sealing compound form together a complete circumferential seal in the contact region 28. Alternatively, the contact region 28 can be formed wider in the area of the walls 24, so that along the whole circumference a sealing effect as well as a force- and torque-transmission are achieved. Between the rim star 20 and the wheel hub 31, a sealing press-fit is used as the seal 34. Because of the connection elements 26 a biasing force is produced, so that the wheel hub 31 and the rim star 20 have a force-locking connection to each other. The biasing force of the connection elements 26 is selected to be so large that the resulting pressing produces a sealing effect between the wheel hub 31 and the rim star 20. The connection portions 32 on the wheel hub 31 are formed as through bores with thread. Thus, for sealing between the connection portion 32 and the connection element 26 a further seal 27 is provided. Alternatively the connection portions 32 can be formed as blind holes, so that the seal 27 can be omitted.

A possible embodiment provides that a brake disc is non-rotationally connected to the rim base 10 or the rim star 20. The non-rotational connection can for example be made by means of a material connection between the brake disc and the rim base 10 or the rim star 20.

### LIST OF REFERENCE NUMBERS

1 drive wheel arrangement

2 rotor

3 stator

4 axis of rotation

5 stator tooth

6 pole shoe

7 connection portion

8 central portion

9 journal

10 rim base

11 outer rim flange

12 inner rim flange

13 outer hump

14 inner hump

15 outer rim shoulder

16 inner rim shoulder

17 magnet

18 side wall

19 opening

20 rim star

21 wheel seat

22 attachment hole

23 spoke

24 wall

25 side wall

26 connection element

27 seal

28 contact region

29 connection region

30 wheel carrier

31 wheel hub

32 connection portion

33 seal element

34 seal

35 motor housing

36 permanent magnet

37 connection portion

38 tapered inclined face for removal from a die

39 metal strip

40 connection element

41 sleeve

42 seal

43 protection layer

44 air gap

1.-15. (canceled)

16. An electromotive drive wheel arrangement for a motor vehicle, comprising:
a stator connectable in a rotationally fixed manner to a wheel carrier and supporting a coil-like winding; and
a rotor in the form of a wheel rim and rotatably supported relative to the stator, and arranged at least partially radially outside around the stator;
wherein the wheel rim includes a rim base and a rim star, connected to each other,
wherein the rim base includes at least partially a fibre-reinforced plastic,
wherein a plurality of magnets are integrated in the rim base by a material connection, and
wherein the rim star includes at least partially a metal material.

17. The electromotive drive wheel arrangement of claim 16, wherein the fibre-reinforced plastic of the rotor is made from a plastic matrix and a semi-finished fibre product.

18. The electromotive drive wheel arrangement of claim 16, wherein the magnets of the rotor are permanent magnets.

19. The electromotive drive wheel arrangement of claim 18, wherein the permanent magnets are connected to the semi-finished fibre product.

20. The electromotive drive wheel arrangement of claim 19, wherein the permanent magnets have a plurality of connection portions for being connected to the semi-finished fibre product.

21. The electromotive drive wheel arrangement of claim 16, wherein the magnets are in the form of coils made from metal wires embroidered into the semi-finished fibre product.

22. The electromotive drive wheel arrangement of claim 16, wherein the rotor forms a motor housing at least partially around the stator.

23. The electromotive drive wheel arrangement of claim 22, wherein the rim star has a closed shape and forms a side wall of the motor housing.

24. The electromotive drive wheel arrangement of claim 16, wherein the stator comprises a wheel hub fixed to the rim star and rotatably supported on the stator, wherein the rim star is sealed relative to the wheel hub.

25. The electromotive drive wheel arrangement of claim 22, wherein a side wall of the motor housing arranged opposite to the rim star is connected to the rim base or formed integrally with the rim base, so that the stator is arranged between the rim star and the side wall arranged opposite to the rim star.

26. The electromotive drive wheel arrangement of claim 25, wherein a sealing element is arranged between the side wall arranged opposite to the rim star, and the stator.

27. The electromotive drive wheel arrangement of claim 16, wherein the rim base and the rim star are connected to each other at least in one of a force-locking and a form-locking manner, and a seal is provided between the rim base and the rim star.

28. The electromotive drive wheel arrangement of claim 16, wherein the rim base and the rim star are materially connected to each other.

29. The electromotive drive wheel arrangement of claim 16, wherein at least one metal strip, rotatable with the magnets, is integrated by a material connection in the rim base.

30. The electromotive drive wheel arrangement of claim 16, wherein a brake disc is rotationally fixedly connected to the rim star or the rim base.
